(19) United States
(12) Patent Application Publication
(10) Pub. No.: US 2015/0377750 A1
(43) Pub. Date: Dec. 31, 2015

(54) Non-Condensing Gas Sampling Probe System

(71) Applicant: TENOVA GOODFELLOW INC., Mississauga, (CA)

(72) Inventors: Vittorio SCIPOLO, Mississauga (CA); Ovidiu NEGRU, Mississauga (CA)

(21) Appl. No.: 14/768,264

(22) PCT Filed: Mar. 3, 2014
(86) PCT No.: PCT/CA2014/000162

§ 371 Date: Aug. 17, 2015

Related U.S. Application Data
(60) Provisional application No. 61/781,613, filed on Mar. 14, 2013.

(51) Int. Cl. G01N 1/22; G01N 1/44; G01N 21/39

(52) U.S. Cl. CPC G01N 1/2252; G01N 21/39; G01N 1/44; G01N 2201/0612; G01N 2021/399

(57) ABSTRACT

A system for measuring water and/or gaseous phase content of high temperature process gases includes a probe for gas sample extraction and cooling temperatures below those which probe filter or gas analyzer components degrade. A heated gas extraction tube provided within the probe interior operates to maintain the thermal stability of the cooled gas sample to preserve chemical integrity.

### RELATED APPLICATIONS

This application claims priority and the benefit of 35 USC §119(e) to U.S. Patent Application Ser. No. 61/781,613, filed 14 Mar. 2013, which is incorporated herein by reference in its entirety.

### SCOPE OF THE INVENTION

The present invention relates to a gas sampling probe, and more particularly a sampling probe which may be provided as part of non-condensing gas sampling probe system adapted for the continuous collection of high temperature water vapour-bearing gas samples, such as those from mid-portions of furnace flue gas streams, while minimizing the condensation of water and/or other condensable gas components from the collected sample.

### BACKGROUND OF THE INVENTION

In commonly owned U.S. Pat. No. 5,777,241 to Evenson, the disclosure which is incorporated herein by reference in its entirety, a water cooled gas sampling probe is disclosed for use in the continuous collection for analysis of furnace off-gases which range in temperatures from about 1000° F. (538° C.) or more, from mid-portions of an off-gas stream. The Evenson probe construction is characterized by a double walled cylindrical collection tube having a length of between about 40 to 50 inches which defines an elongated gas flow passage, and in which is provided a particle filter element positioned in the probe at its innermost end. The double wall construction of the probe is divided internally into coolant fluid channels through which coolant liquid is pumped to cool the extracted gas sample as it travels or is drawn into from the inlet end of the probe, and along its length towards the filter.

While the probe described in U.S. Pat. No. 5,777,241 provides a robust and simplified construction, the applicant has appreciated that the probe design presents limitations when used for the analysis of the water content of collected gas samples. In particular, the applicant has appreciated that when collecting high temperature gas samples from process flue streams, such as those at temperatures exceeding 1000° F. (538° C.), as the extracted gas sample moves either within the probe and/or from the probe to a gas analyzer, as a result of its residence time, the collected gas sample may cool below temperatures at which water vapour in the sample condenses and/or water therein may otherwise precipitate. By way of example, FIG. 1 illustrates a temperature profile of furnace off-gas samples collected using the existing Evenson probe design, and in which the relative displacement of the probe filter element from the probe tip is shown graphically in zone 8. As the collected gas sample moves initially from the open inlet end of the sampling probe and along the probe interior towards the innermost filter, the extracted gas sample cools. As shown graphically, sample cooling may occur within the probe to temperatures where water vapour in the gas sample may precipitate, even where initial process off-gas temperatures exceed 3000° F. As such, existing probe and analyzer designs may be susceptible to effect the precipitation of water from within collected gas samples prior to analysis, resulting in the incorrect or inaccurate determination of the water component content of the off-gas stream.

### SUMMARY OF THE INVENTION

The present invention provides for a gas sampling probe which is particularly suited for the collection and analysis of furnace and other process off-gas samples which include water vapour and/or other condensable components.

In another non-limiting construction, the invention provides a non-condensing probe for use in a furnace gas collection and control system for substantially continuous sampling and conveyance of high temperature gases to a gas analyzer, and which is configured to maintain collected gas samples within a preselected temperature range, and preferably at a temperature above that at which water and/or other gaseous phases will condense, from initial gas collection up to analysis.

In one non-limiting construction, the present invention provides a system for the substantially monitoring of a process off-gas stream such as high temperature furnace off-gases, and preferably steel making furnace off-gases process temperatures of 1000° F. (538° C.) or more, preferably at least 2000° F. or more, and most preferably of 3000° F. (1649° C.) or more, whilst allowing for the reliable collection and analysis of water content in the off-gas stream. A gas sampling probe is provided in the system, and which is constructed to moderate the temperature of the collected gas sample so as not to damage probe and/or analyzer components, whilst substantially preserving the integrity of the sample water and/or condensable component concentrations. Preferably, the probe is provided with an elongated construction having a length of at least about 70 cm or more, and preferably between about 1 and 2 metres, to enable the sighting of the probe gas inlet at a point of sampling where the gas sample is extracted within a mid-portion of the process off-gas stream. More preferably, the probe has a heated gas extraction and/or filter-snorkel assembly which is configured to collect and maintain the selected thermal stability of the extracted gas sample, and which is shielded within the body so as to withstand high temperature cycling associated with the start-up and shutdown of steel furnace operations.

Accordingly, in one embodiment, the invention provides a method and apparatus used to facilitate measuring of the water and/or other gaseous phase content of a high temperature process gas stream, such as a furnace off-gases stream, using a gas analyzer. Preferably, the system is geared towards the steel making industry where the quantities of off-gases coming out of steel making conversion vessels are large, contain large quantities of particulates, and have very high temperatures. More preferably, the invention provides a probe and/or method for precisely and continuously extracting and measuring the content of water vapour, and/or the vapour phases which may be susceptible to condensation in off-gases coming out of conversion vessels, and preferably those used in steel making (i.e. EAF and/or BOF furnaces). In one possible construction, a probe is provided which is adapted to extract and initially cool a collected gas sample to a temperature generally below that at which probe filter and/or gas analyzer components will degrade. A heated gas conduit or extraction tube is provided within the probe interior is operable to maintain the thermal stability of the extracted gas sample within a preselected temperature range. To overcome one disadvantage associated with classical methods of off-gas measurement by process conditions (i.e. extremely high temperatures, inconsistent gas composition, inconsistent particulates content, presence of flame conditions at the point of measurement/sampling, and so on), preferably, the preselected temperature range is chosen as a range of temperatures selected to preserve the chemical integrity of the extracted gas sample, and prevent water condensation and/or condensation of other condensable gases of interest.

The current invention allows more accurate analysis of the water composition of gases coming out of a conversion vessel. In a more preferred embodiment, the collected data is used to calculate the mass balance and the energy balance in the vessel, and provide for the dynamic control of the steel making process in response thereto; and/or better control of emissions through the associated fume system.

In another embodiment, the system uses a tunable diode laser (TDL) analyzer located in a remote location. The TDL analyzer is optically and/or electrically associated with a measurement sensor or cell located in a gas conduit which is fluidically coupled to the probe for analysis of the extracted off-gas sampled by the probe to determine the water quantity present in the collected samples. In a preferred mode, the system incorporates a probe to extract and collect a gas sample from the process stream or exhaust gas flow, with the probe constructed to initially cool and then subsequently heating the collected sample. The probe and/or gas conduit operable to deliver the sample to the measurement cell at a temperature above the condensation point of the water vapour phase therein, and more preferably at a temperature range below that which probe component damage occurs, and above a condensation temperature of water or other vapour phase components of interest. In this manner, the system operates to maintain in the extracted sample the original quantity of water vapour (V) and/or other gas components which may be susceptible to condensation, precipitation and/or reaction, as they exist at the point of sampling. Most preferably heating of the extracted gas as it moves from the probe and through the gas conduit is effected to maintain a substantially stable thermal gas temperature as the extract gas sample moves to the measurement cell.

In a most preferred embodiment, sampling of the off-gas from the process stream is accomplished using a gas sampling probe which is provided with a liquid cooled tubular probe body in which is positioned in an extraction tube assembly. The probe is designed to provide the analysis system with a means of reliable continuous sampling capability, with a reduced maintenance cycle. The sampling probe construction is preferably provided so that the body and/or extraction tube assembly are interchangeable to allow for the more readily custom design of individual probes of different lengths for customization for specific furnace applications, and which allow probes to be more readily adapted for use with different fume systems and/or in the sampling of different condensation gases. More preferably, the probe design allows for filtration and the filtered sampling collection of process gas sample to be positioned and maintained at a predictable or constant distance from a sample gas inlet end of the probe, across a number of different probe lengths.

Most preferably, the gas collection tube assembly positions a sampling filter or filtration assembly at a recessed location within a surrounding cooling tube or jacket. The filter is provided within the cooling jacket at a location which is selected whereby the sampled gas is cooled to a temperature below that which will result in degradation and/or failure of the filter, but which is maintained above the condensation point of any liquid vapour in the collected gas.

Accordingly, the present invention resides in at least the following non-limiting aspects:

1. A non-condensing gas sampling probe system for continuous extraction and analysis of high temperature process off-gases from a point of sampling in a gas stream, the system comprises a gas extraction probe, a gas analyzer assembly having a sensor, the extraction probe including, an axially elongated tubular body having a longitudinal length of at least 5 metres for positioning within said gas stream and defining a hollow probe interior, said body extending from a proximal gas inlet end open to said body interior to a distal end, said inlet end positionable at said point of sampling to provide fluid communication between said gas stream and said probe interior, a gas collection tube assembly disposed within said probe interior for drawing an off-gas sample from the gas stream through the probe interior, said collection tube assembly including, an axially extending gas extraction tube for conveying said off-gas sample from the probe interior, the extraction tube extending from a rearward end spaced towards the distal end of the tubular body to a forward end spaced towards the gas inlet end, the rearward end fluidically communicating with said gas conduit, a filter element mounted to the forward end for filtering particulate matter from the off-gas sample as said off-gas sample is drawn into the extraction tube, a heater assembly disposed about said extraction tube, and a probe cooling assembly for cooling assembly for cooling the off-gas sample to a predetermined temperature range as it is drawn from the gas inlet end to the collection tube assembly, and wherein said heater assembly is activatable to maintain the off-gas sample within the predetermined temperature range as it is drawn through the filter element and along the gas extraction tube.
2. A gas sampling probe for extracting and conveying a high temperature process off-gas sample from a point of sampling in a gas stream to a gas analyzer assembly, said probe comprising, an elongate body adapted for positioning within said gas stream and defining a hollow probe interior, said body comprising a gas inlet end open to said body interior and positionable at said point of sampling and providing fluid communication between said gas stream and said probe interior, a gas collection tube assembly disposed within said probe interior, said collection tube assembly including, a filter element for filtering particulate matter from an off-gas sample collected in the probe interior as said off-gas sample is drawn therethrough, a gas extraction tube for conveying said off-gas sample from the probe interior to the gas analyzer assembly, the extraction tube extending from a forward end to a rearward end, the forward end being in fluid communication with said filter element, the rearward end being adapted for fluidic communication with said gas analyzer assembly, a heater assembly disposed about at least part of said extraction tube and activatable to maintain a temperature of said off-gas sample moving therethrough within a predetermined temperature range.
3. A non-condensing gas sampling probe for extracting and conveying a high temperature process off-gas sample from a point of sampling in a gas stream, said probe comprising, an axially elongated tubular body defining a hollow probe interior, said body extending from a proximal gas inlet end open to said body interior to a distal end, and being positionable with said inlet end at said point of sampling to provide fluid communication between said gas stream and said probe interior, a gas collection tube assembly disposed within said probe interior, said collection tube assembly fluidically coupled to a gas analyzer vacuum source for drawing an off-gas sample from the gas stream through the probe interior, said collection tube assembly including, an axially extending gas extraction tube for conveying said off-gas sample from the probe interior, the extraction tube extending from a rearward end spaced towards the distal end of the tubular body to a forward end spaced towards the gas inlet end, the rearward end fluidically communicating with said vacuum source, being adapted for fluidic communication with said gas analyzer assembly, a filter element mounted to the forward end for filtering particulate matter from the off-gas sample as said off-gas sample is drawn into the extraction tube, a heater assembly disposed about said extraction tube, and a probe cooling assembly for cooling assembly for cooling the off-gas sample to a predetermined temperature range as it is drawn from the gas inlet end to the collection tube assembly, and wherein said heater assembly is activatable to maintain the off-gas sample within the predetermined temperature range as it is drawn through the filter element and along the gas extraction tube.
4. An aspect according to any of the preceding aspects, wherein said gas stream comprises a steel furnace conversion vessel off-gas stream, and said predetermined temperature range is selected at between about 225° F. and 900° F., and preferably between about 250° F. and 750° F., the heater assembly comprises: a heating coil thermally communicating with and extending along a longitudinal length of said extraction tube an insulating jacket disposed about and thermally insulating said heater coil from said probe interior, and axially shielding tube, said shielding tube substantially encasing and isolating said shielding jacket from the probe interior, a power supply controller for supplying power to said heating coil, and at least one temperature sensor electronically communicating with said power supply controller, said temperature sensor operable to a temperature of said off-gas sample along at least a portion of said extraction tube.
5. An aspect according to any of the preceding aspects, wherein the gas analyzer assembly further includes: an analyzer electronically communicating with the sensor for sensing and outputting to said analyzer data representative of water vapour content of said gas stream, a conduit heater activatable to heat said gas conduit tube to maintain the off-gas sample therein substantially within said predetermined temperature range.
6. An aspect according to any of the preceding aspects, wherein the heater assembly comprises: a heater coil thermally communicating with and extending along a longitudinal length of said extraction tube, and an insulating jacket disposed about and thermally insulating said heater coil from said probe interior.
7. An aspect according to any of the preceding aspects, wherein the heater assembly comprises: a heater coil thermally communicating with and extending along a longitudinal length of said extraction tube, and an insulating jacket disposed about and thermally insulating said heater coil from said probe interior.
8. An aspect according to any of the preceding aspects, wherein the gas collection tube assembly is provided as an interchangeable modular preassembly, each preassembly characterized by one said gas extraction tube having an axial length selected for locating the forward end a predetermined distance from the gas inlet end to effect desired cooling of said collected off-gas sample prior to drawing through said filter element, the probe further comprising a coupling for releasably securing the gas collection tube assembly in said probe interior.
9. An aspect according to any of the preceding aspects, wherein the filter element comprises a replaceable stainless steel filter.
10. An aspect according to any of the preceding aspects, wherein said predetermined temperature range is selected less than about 350° F. than a temperature of said process off-gas sample at said point of sampling, said body comprising a generally tubular body elongated along an axis having a sidewall extending radially about said axis, said sidewall comprising at least one coolant fluid passage for cooling said process off-gas sample as said off-gas sample is drawn through said gas inlet end into said probe interior and to said filter element.
11. An aspect according to any of the preceding aspects, wherein said predetermined temperature range is selected higher than a condensation point of water and lower than a thermal degradation temperature of at least one of said filter element and said gas analyzer assembly.
12. An aspect according to any of the preceding aspects, wherein said gas stream comprises a steel furnace conversion vessel off-gas stream, and said predetermined temperature range is selected at between about 225° F. and 900° F., and preferably between about 250° F. and 750° F.
13. An aspect according to any of the preceding aspects, wherein the heater assembly comprises: a heater coil thermally communicating with and extending along a longitudinal length of said extraction tube, and an insulating jacket disposed about and thermally insulating said heater coil from said probe interior.
14. An aspect according to any of the preceding aspects, wherein the heater assembly further comprises a generally cylindrical shielding tube, said shielding tube substantially encapsulating and isolating said insulating jacket from said probe interior, and being radially spaced a distance of at least about 1 cm, and preferably at least 1.5 cm from said body sidewall, said shielding tube having a generally smooth outer surface selected to minimize the adherence of process dust and/or debris thereto.
15. An aspect according to any of the preceding aspects, wherein the heater coil comprises an electric coil, said heater assembly further comprising: a power supply controller for supplying power to said electric coil, and at least one temperature sensor electronically communicating with said power supply controller, said temperature sensor for sensing a temperature of said off-gas sample along at least a portion of said extraction tube.
16. An aspect according to any of the preceding aspects, wherein the gas analyzer assembly includes: an analyzer, a sensor electronically communicating with said analyzer and for sensing and outputting to said analyzer data representative of water vapour content of said process gas sample, a gas conduit tube fluidically coupled to the rearward end of the gas extraction tube for receiving and conveying the off-gas sample from the collection tube assembly to the sensor for analysis, and a conduit heater activatable to heat said gas conduit tube to maintain the off-gas staple therein substantially within said predetermined temperature range.
17. An aspect according to any of the preceding aspects, wherein the heater coil comprises an electric coil, said heater assembly further comprising: a power supply controller for supplying power to said electric coil, and at least one temperature sensor electronically communicating with said power supply controller, said temperature sensor for sensing a temperature of said off-gas sample along at least a portion of said extraction tube.
18. An aspect according to any of the preceding aspects, wherein the gas collection tube assembly is provided as an interchangeable modular preassembly, each preassembly characterized by one said gas extraction tube having an axial length selected for locating the forward end a predetermined distance from the gas inlet end to effect desired cooling of said collected off-gas sample prior to drawing through said filter element, the probe further comprising a coupling for releasably securing the gas collection tube assembly in said probe interior.
19. An aspect according to any of the preceding aspects, wherein said predetermined temperature range is selected less than a thermal degradation temperature of said filter element and higher that a condensation point of water in said off-gas sample.
20. An aspect accordingly to any of the preceding aspects, wherein said body comprises an inner sidewall and an outer sidewall, wherein said cooling assembly comprises at least one annularly extending liquid coolant fluid passage extending between said inner and outer sidewall.
21. An aspect according to any of the preceding aspects, wherein said gas stream comprises a steel furnace conversion vessel off-gas stream, and said predetermined temperature range is selected at between about 225° F. and 900° F., and preferably between about 250° F. and 750° F., the heater assembly comprises: a heating coil thermally communicating with and extending along a longitudinal length of said extraction tube an insulating jacket disposed about and thermally insulating said heater coil from said probe interior, and axially shielding tube, said shielding tube substantially encasing and isolating said shielding jacket from the probe interior, a power supply controller for supplying power to said heating coil, and at least one temperature sensor electronically communicating with said power supply controller, said temperature sensor operable to a temperature of said off-gas sample along at least a portion of said extraction tube.
22. An aspect according to any of the preceding aspects, wherein the gas collection tube assembly is provided as an interchangeable modular preassembly, each preassembly characterized by one said gas extraction tube having an axial length selected for locating the forward end a predetermined distance from the gas inlet end to effect desired cooling of said collected off-gas sample prior to drawing through said filter element, the probe further comprising a coupling for releasably securing the gas collection tube assembly in said probe interior.
23. An aspect according to any of the preceding aspects, wherein said tubular body has a length selected greater than 1 metre, and said filter element is located within 0.5 metres from the gas inlet end.

### BRIEF DESCRIPTION OF THE DRAWINGS

Reference may now be had with the following detailed description taken together with the accompanying drawings, in which:

FIG. 1 illustrates graphically the temperature change of a high temperature process gas as it moves along the interior of a conventional water cooled sampling probe;

FIG. 2 illustrates schematically a non-condensing off-gas sampling and analysis system in accordance with a preferred embodiment of the invention, illustrating the positioning of a gas sampling probe within a furnace off-gas exhaust duct;

FIG. 3 shows a vertical sectional view of the gas sampling probe shown in FIG. 2;

FIG. 4 shows a cross-sectional view of the gas sampling probe illustrated in FIG. 3, taken along line 4-4′;

FIG. 5 shows an enlarged partially cutaway schematic view of the bottom-most inlet tip of the gas sampling probe shown in FIG. 3;

FIG. 6 shows schematically an enlarged partial cross-sectional view of the upper-most end portion of the gas sampling probe shown in FIG. 3;

FIG. 7 shows schematically a cross-sectional view of the heated gas collection tube assembly and gas conduit used in the off-gas sampling and analysis system of FIG. 2;

FIG. 8 shows an exploded view of the heated gas collector tube assembly used in the probe of FIG. 3;

FIG. 9 illustrates graphically the temperature change of a process flue gas sampled at 1000° F. (538° C.) at a point of sample, as it moves from the point of sampling along the interior of the sampling probe in accordance with the present invention;

FIG. 10 illustrates graphically the temperature change of a process flue gas at 2200° F. (1204° C.) at a point of sample, as it moves from the point of sampling along the interior of the sampling probe in accordance with the present invention;

FIG. 11 illustrates graphically the temperature change of a process flue gas at 3300° F. (1816° C.) at the point of sample, as it moves from the point of sampling along the interior of the sampling probe in accordance with the present invention; and

FIGS. 12a to 12d illustrate partially cut-away cross-sectional views of inlet tip configurations of the gas sampling probe shown in FIG. 3, in accordance with alternate embodiments of the invention.

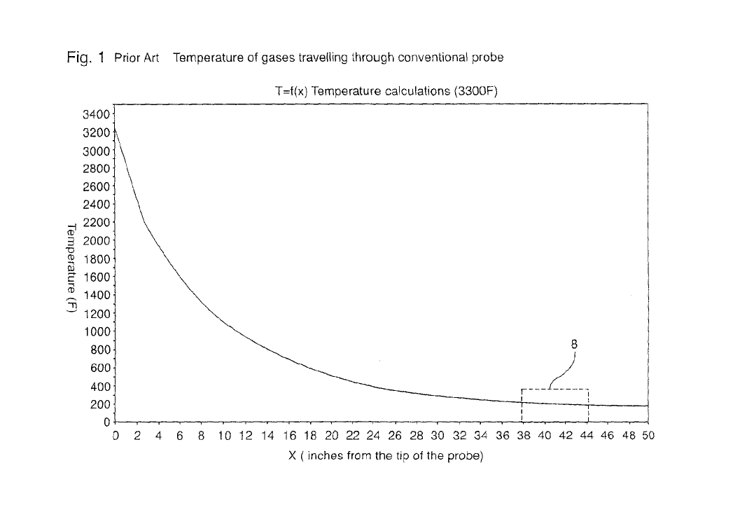

### DETAILED DESCRIPTION OF THE PREFERRED EMBODIMENTS

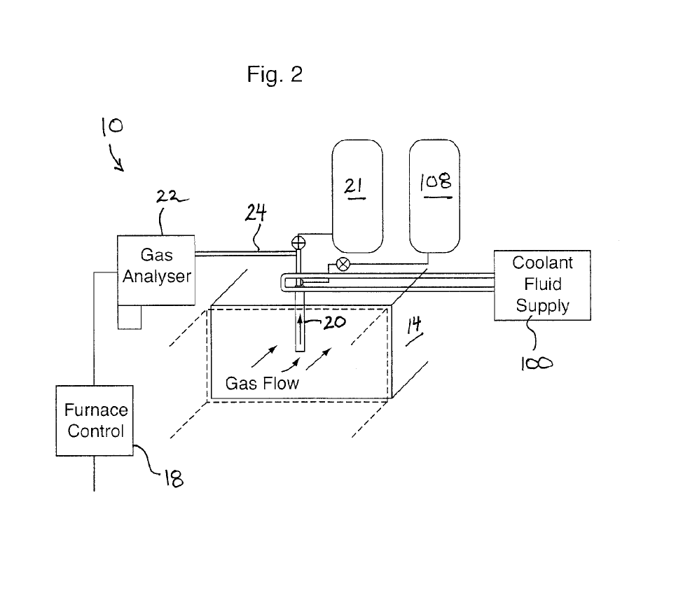

FIG. 2 illustrates schematically a non-condensing off-gas analysis system 10 used in the continuous collection and analysis of furnace off-gases flowing in a steel making furnace flue duct 14 in accordance with a preferred embodiment. The off-gas analysis system 10 includes a liquid cooled gas sampling probe 20, analyzer vacuum source 21, and a TDL off-gas analyzer 22 which, during gas sampling, is provided in gaseous communication with the probe 20 by a gas conduit line 24. The gas analyzer 22 is in turn electronically connected to a furnace control unit 18 which is operable to regulate furnace operating parameters, having regard to the properties of the sensed gas.

As will be described, to simplify manufacturing and/or allow design requirements associated with the production of gas sampling probes 20 for a variety of different types and sizes of fume system applications, the present system incorporates a gas sampling probe 20 which is provided with modular components which allow for the simplified assembly of probes 20 having a variety of individual lengths, each adapted to minimize the condensation of vapour in sampled gases, depending on the flue duct 14 construction and the final point of sampling.

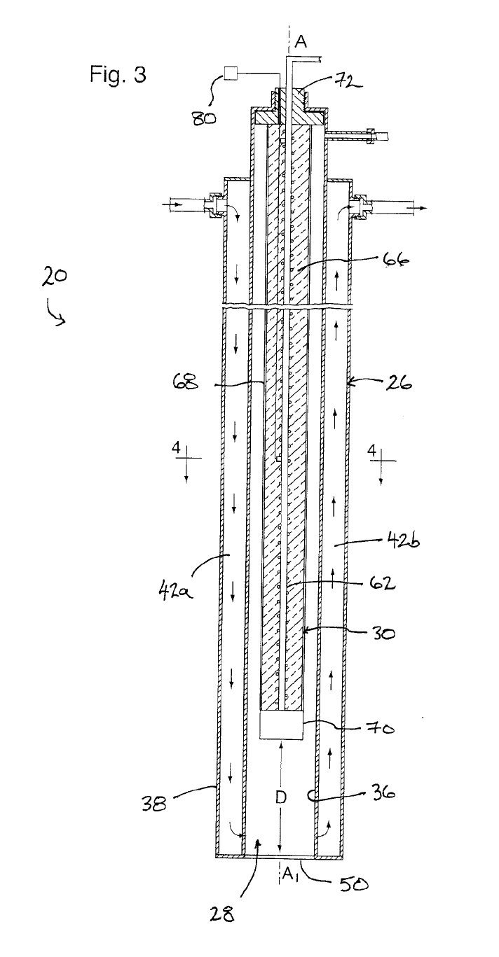

The gas sampling probe 20 is shown best in FIG. 3 as having a generally elongated construction, with a length in the direction of axis A-A₁, selected at between about 0.75 and 2.0 metres. The probe 20 includes an outer stainless steel cylindrical cooling jacket or body 26 which defines a hollow probe interior 28, and in which an axially elongated cylindrical heated gas collection tube assembly 30 is co-axially disposed therein.

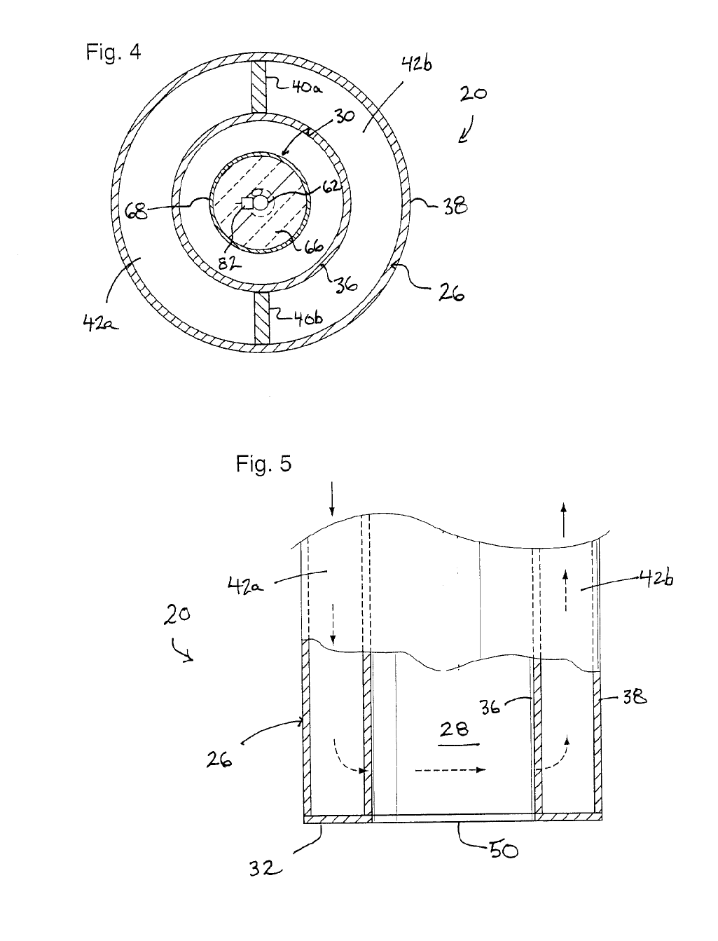

The probe body 26 is shown best in FIGS. 4 to 6 as formed as a double-walled hollow tube, with the interior 28 having an inner diameter selected at between about 7 and 20 cm. The body 26 includes a stainless steel inner sidewall 36, disposed concentrically within a cylindrical outer wall 38 opposing end portions of the outer sidewall 38 are fluidically sealed with the inner sidewall 36 by distalmost and proximal sealing webs 32,33 provided with an internally threaded and axially aligned threaded socket 34. The proximal end of the sidewall 36 may further be configured for releasable mechanical engagement with an externally threaded fitting 35 of the gas collection tube assembly 30. The inner and outer walls 36,38 are joined along longitudinally spaced portions by a pair of radially opposing webs 40a,40b (FIG. 4). The webs 40a,40b which extend slightly less than the axial length of the cooling body 26 to a distance spaced from a probe inlet end 50. The webs 40a,40b divide interior spacing between the sidewalls 36,38 into a pair of coolant flow channels 42a,42b (FIG. 3). The flow channel 42a is provided with an associated fluid inlet 46a which is provided in fluid communication with a coolant fluid supply 100. A corresponding fluid outlet 46b is formed in the flow channel 42b, and provides return fluid flow back to a coolant fluid supply 100 (FIG. 2), allowing for its recirculation.

As shown best in FIGS. 4 and 5, the proximal-most ends of the inner and outer sidewalls 36,38 are joined at the inlet end 50 by the radially disposed sealing web 32 which allows for coolant fluid to flow from the supply 100, into the flow channel 42a via fluid inlet 46a; and therefrom into the flow channel 42b, and outwardly via fluid outlet 46b for recirculation.

The probe body 26 is operable to initially cool the sampled gas as it is drawn through the inlet end 50 of the probe 20, and into and along the body interior 28. Most preferably, in the probe interior 28, the sampled gas is cooled to a predetermined temperature which is less than about 900° F., and preferably less than about 750° F., to minimize thermal damage to the probe components and/or those of the gas analyzer 22.

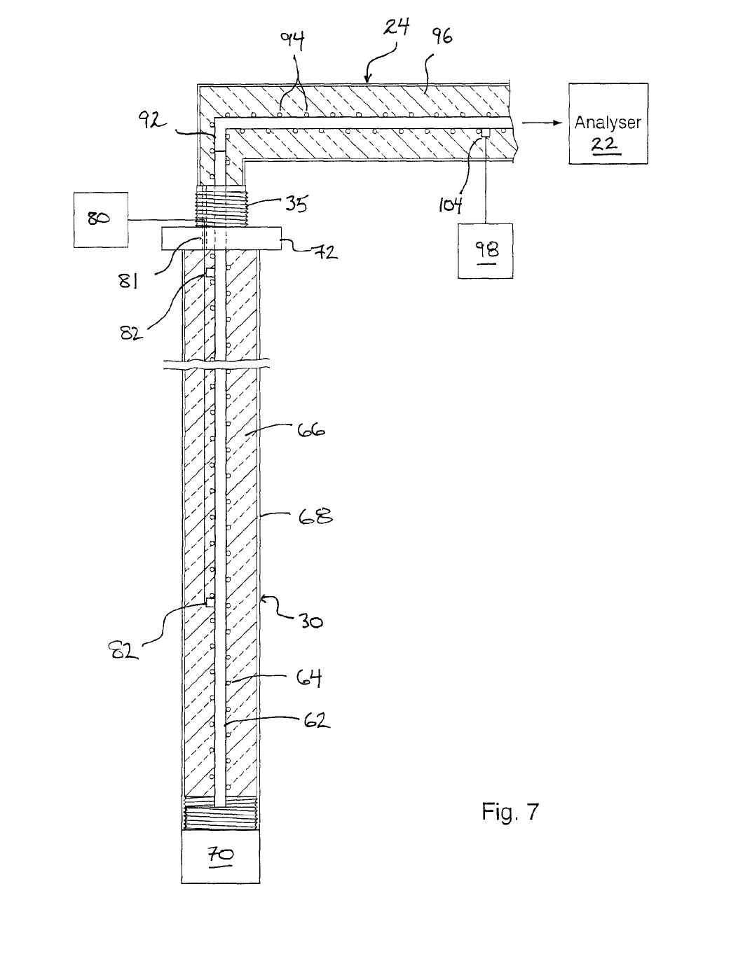

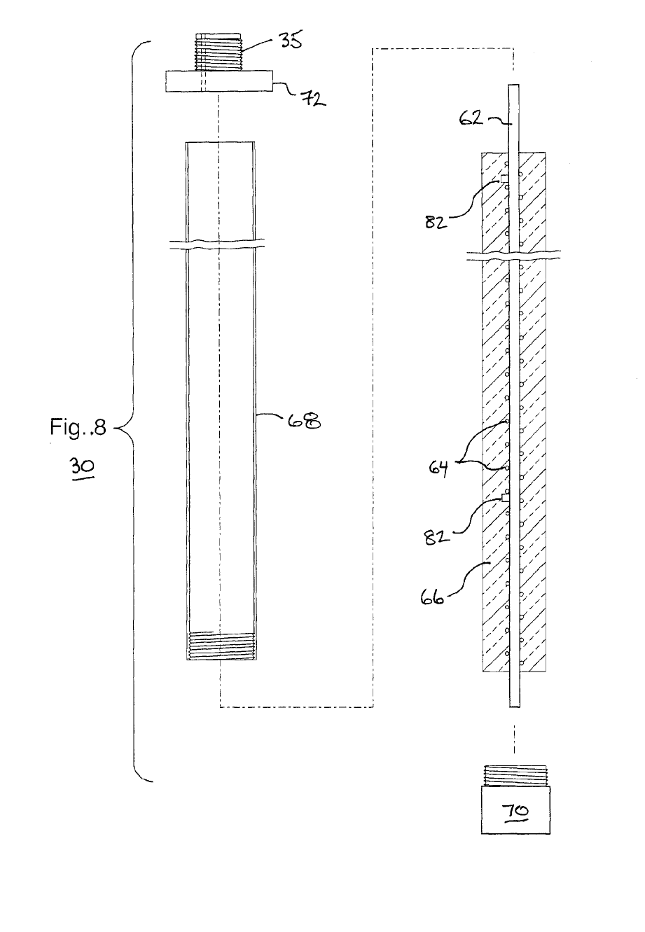

FIGS. 7 and 8 illustrate best the gas collection tube assembly 30 being axially elongated as the gas collection tube assembly includes an axially disposed stainless steel sample extraction tube 62, a heating coil 64, a thermally insulating jacket 66, a stainless steel shielding tube 68, a filter element 70, and a mounting collar 72. In a most preferred construction, the sampling probe 20 is provided with a stainless steel filter as the filter element 70. Filters having a standard length of between about 1 and 10 inches, and preferably up to 7 inches may be used, depending on the concentrations of particulate matter typically found in the process gas stream.

The sample extraction tube 62 communicates with the vacuum source 21 shown in FIG. 2 and is provided for conveying gas samples which have been drawn from the duct 14 into the probe interior 28 into the gas conduit line 24. The extraction tube 62 is formed as an elongated stainless steel cylindrical tube, having a diameter selected at between about 0.5 and 3 cm, and most preferably between about 1 and 2 cm.

The heating coil 64 is preferably wound helically about or positioned longitudinally in juxtaposed contact along the longitudinal length of the exterior of the extraction tube 62, so as to be in thermal communication therewith. The heating coil 64 is electrically connected with a power supply controller 80 by way of wire passage 81 (FIG. 7) formed in the mounting collar 72. The heating coil 64 is in turn encased by the thermal insulation jacket 66. The thermal insulation jacket 66 is preferably formed as a 1 to 3 cm thick layer of insulation. The jacket 66 may be formed from a variety of different insulating materials, however, in a most preferred construction is provided as a high temperature mineral fiber insulation. In this manner, the heating coil 64 is protected from the high temperature environment of the furnace flue duct 14 by way of both the cooling body 26 and the surrounding 1 to 3 cm thick layer of thermal insulation of the insulation jacket 66.

One or more thermocouple sensors 82 are most preferably positioned approximately along a mid-portion of the extraction tube 62, and which is adapted to provide signals representative of the temperature of extracted gas sample as it moves longitudinal through the tube 62. Both the heating coil 64 and thermocouple sensors 82 are electronically coupled to the power supply controller 80. The power supply controller 80 operates to regulate power flow to the heater coil 64 in response to temperature signals supplied by the thermocouple sensors 82. Preferably, the power supply controller 80 and heater coil 64 operate to maintain a minimum temperature of the collected off-gas sample as it moves along the extraction tube 62 at a preselected minimum temperature, and most preferably a temperature of at least about 220° F. and preferably above 250° F., to substantially prevent the condensation of any water vapour therein.

As shown best in FIGS. 7 and 8, the mounting collar 72 is provided with the threaded portion or fitting 35 configured for mated threshold engagement within the socket 34, to releasably secure the gas collection tube assembly 30 in a co-axially aligned orientation within interior 28 of the probe body 26. In a simplified assembly, the shielding tube 68 and sample extraction tube 62 are fixedly secured to the mounting collar 72 by weldments, with the heating coil 64 and insulating jacket 66 encased by the shielding tube 68 as a single preassembly, allowing for simplified removal for replacement and/or repair.

The shielding tube 68 is preferably provided with a smooth stainless steel cylindrical outer surface and has a radial diameter selected at between about 2 and 8 cm. As shown best in FIG. 3, the diameter of the shielding tube 68 is selected such that the sample collection tube assembly 30 has a radial diameter between about 1 and 6 cm, and most preferably about 4 cm smaller than the radial diameter of the body interior 28. In this manner, a spacing is maintained between the shielding tube 68 and inner sidewall 36 which is selected to minimize clogging and/or the collection of process dust or debris therebetween.

The stainless steel filter element 70 is provided for attachment to the distalmost end of the extraction tube 62 which is closest to the probe inlet end 50. Most preferably, the filter element 70 is configured for threaded coupling onto the end of the extraction tube 62, allowing for its simplified replacement in the event of damage or clogging.

The extraction tube 62 is formed with an overall axial length selected so that when installed, the filter element 70 is positioned inwardly from the axial centre of the inlet end 50 of the sampling probe 20. More preferably, the length of the tube 62 is chosen so that a distal-most end of the filter element 70 locates a predetermined distance D (FIG. 3) from the probe inlet end 50. The distance D is chosen whereby the extracted sample gas, on passing through the filter element 70 has had sufficient residence time in the probe interior 28 to be cooled by the probe cooling jacket 26 to a temperature below the thermal limit or temperature which would result in failure and/or degradation of the filter element 70 and/or the gas analyzer 22, but which remains above the condensation point of any water in the gas sample.

Preferably, the distance D is selected to allow for the cooling of the extracted gas sample to a temperature range which is preselected to be below 900° F., and preferably below about 750° F., but at or above 250° F., so as to otherwise prevent in condensation or precipitation of water vapour and/or other condensable vapours from the extracted gas sample prior to its collection by the extraction tube 62. In this manner, on entering the extraction tube 62, the gas sample is thereafter maintained at temperatures above the water vapour condensation point, ensuring that the water content of the extracted sample gas is maintained. For most steel plant operations, a preferred distance D is selected at between about 6 and 24 inches from the center of the probe inlet end 50, and most preferably about 12±3 inches.

The threaded filling 35 on the mounting collar 72 and its mechanical engagement with a threaded socket 34 allows for the entire gas collection tube assembly 30 to be detachably coupled from the probe 20 for repair and/or replacement. Further, probe 20 may be readily manufactured and/or customized for a variety of different site applications, by substituting gas collection tube assemblies 30 of varying lengths, having regard to the initial temperature of the off-gas to be sampled and the degree of cooling desired.

As shown best in FIG. 7, the collected gas sample moves from the gas collection tube assembly 30 to a sensor 98 of the TDL analyzer 22 for analysis via the gas conduit line 24. Although not essential, as shown best in FIG. 7, most preferably the gas conduit line 24 is also provided with a stainless steel conduit tube 92 fluidically coupled to the extraction tube 62, and a separate heating coil 94 and insulating jacket 96. The heating coil 94 is electrically connected to either the power supply controller 80, or more preferably a separate dedicated power supply controller 98. A second thermocouple sensor 104 is further electrically provided in communication with the power supply controller 98, and operates to provide signals respecting the temperature of the conduit line 24. In this manner, the controller 102 is operable to independently actuate the heating coil 94 to maintain the sampled gas as it moves from the extraction tube 62 and through the gas conduit line conduit tube 92 at a preselected temperature. Most preferably, the power supply controller 98 operates to effect heating of the gas sample moving along the conduit tube 92 above the condensation point of water in the gas sample moving therethrough, and most preferably which coincides with the predetermined temperature range with which the power supply controller 80 maintains the extraction tube 62.

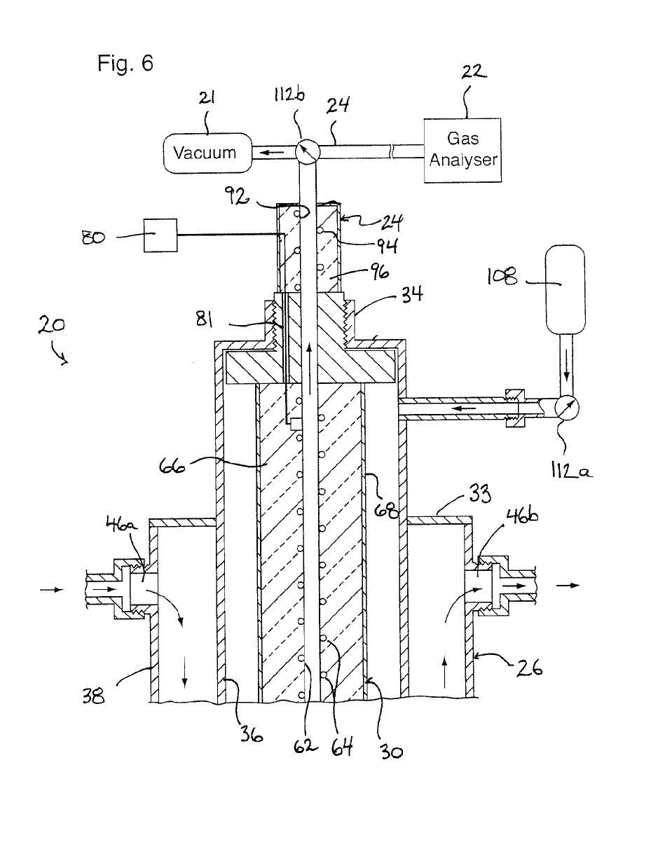

Although not essential, most preferably, the sampling probe 20 is connected to a pressurized air source 108 (FIG. 6) by way of associated valving 112a,112b. The valves 112a,112b are selectively activatable to allow reverse backflow cleaning of the interior 28 of the cooling jacket and optionally cleaning of the extraction tube 62 26 to dislodge any dust or other debris which may accumulate therein during sampling operations.

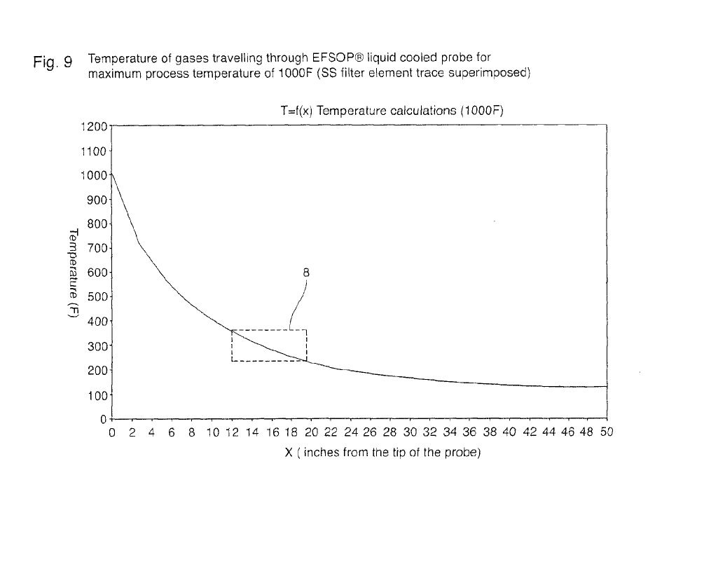

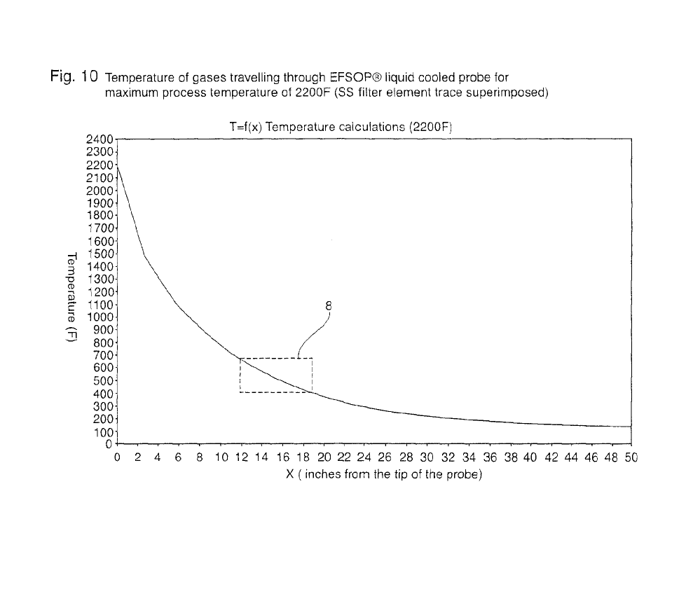

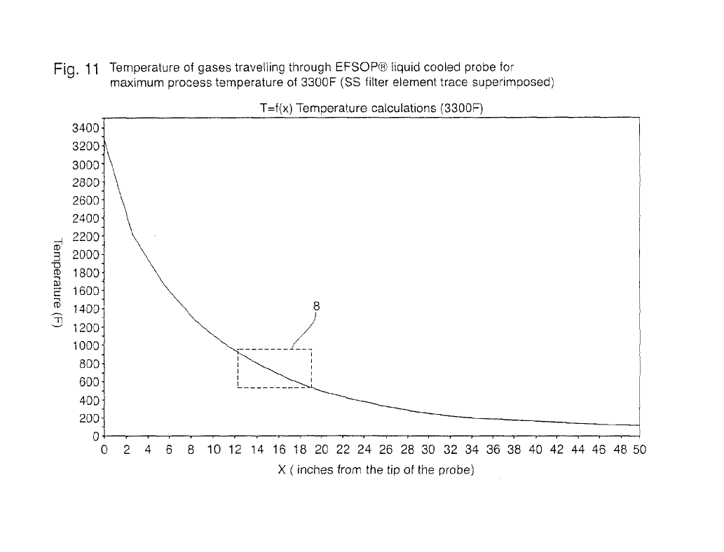

FIGS. 9 to 11 illustrate graphically the preferred relative positioning of the filter element 90 within the cooling probe (i.e. see superimposed trace zone 8: illustrated at approximately 12 to 19 inches from the probe inlet-opening 50 shown in FIG. 3). Preferably, with the illustrated positioning, the extracted gas sample, on reaching the filter element 70 is cooled to a temperature range of between about 250° F. (i.e. above the condensation rate of the liquid) to about 950° F., (i.e. below that which would result in significant degradation and/or damage to the filter element 70), in the case of high temperature furnace off-gases. The applicant has further appreciated that the positioning of the filter element 70 towards the inlet end 50 of the probe 20 advantageously allows for the use of longer probe designs, avoiding the collection and extraction off-gases from peripheral cooler off-gas stream regions, and where for example gas cooling may result in the condensation of not only water, but other vapour components therefrom and/or loss of moisture which could result in erroneous gas constituent analysis.

The applicant has appreciated that by establishing a constant variable D, the construction of the probe 20 may advantageously be readily modified for use with gas analysis systems across a variety of different sized and/or configured gas flue vents 14. In particular, the present construction allows for the use of cooling jacket tubes 26 of various axial lengths, as may be necessary to provide the desired positioning of the probe inlet end 50 at the optimum point of sampling within the office gas stream. Once an optimal probe tube length is selected, the gas collection assembly 30 is then chosen or customized with a corresponding extraction tube 62 length to provide the selected distance D between the inlet end 50 and filter 70. In this manner, a number of different probe designs may be used in the gas analyzer system 10, without the requirement of reconfiguring or reprogramming the gas analyzer 22 itself or its software.

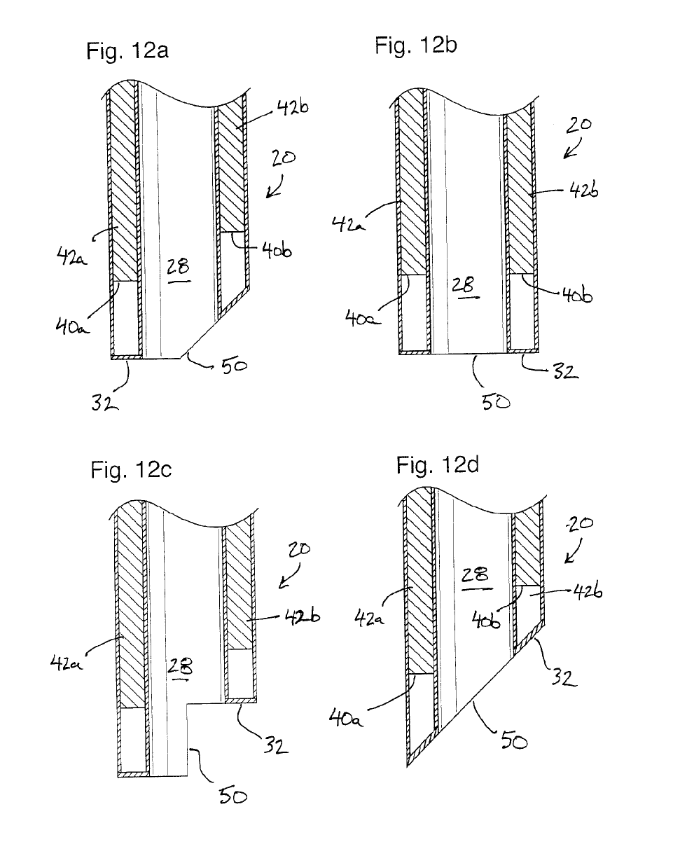

While FIG. 3 illustrates the gas sampling probe 20 as having a generally flat inlet end opening 50 which orients transversely to the probe axis A-A₁, the invention is not so limited. Reference may be had to FIGS. 12a, 12b, 12c and 12d which illustrate alternate possible probe inlet end 50 constructions which could also be used and will now become apparent, and wherein like reference numerals are used to identify like components.

Although in a simplified construction, the filter element 70 is provided as a stainless steel filter assembly, it is to be appreciated that a variety of different types of filters could also be used including without restriction ceramic filters, cloth or mesh filters and the like.

While the preferred embodiment describes the use of the probe 20 as maintaining the collected gas sample above the condensation temperature of water, the invention is not so limited. It is to be appreciated that the probe 20 of the present invention may be used in a variety of different gas sampling applications, where maintaining a regulated sample gas temperature is of interest.

Although the detailed description describes and illustrates the various preferred embodiments, the invention is not specifically limited to the best mode which is disclosed. Many modifications and variations will now occur to persons skilled in the art. For a definition of the invention, reference may be had to the appended claims.

1. A non-condensing gas sampling probe system for continuous extraction and analysis of high temperature process off-gases from a point of sampling in a gas stream,
the system comprises a gas extraction probe, a gas analyzer assembly having a sensor, and a gas conduit in fluidic communication with the extraction probe,
the extraction probe including,
an axially elongated tubular body having a longitudinal length of at least 5 metres for positioning within said gas stream and defining a hollow probe interior, said body extending from a proximal gas inlet end open to said body interior to a distal end, said inlet end positionable at said point of sampling to provide fluid communication between said gas stream and said probe interior,
a gas collection tube assembly disposed within said probe interior for drawing an off-gas sample from the gas stream through the probe interior, said collection tube assembly including,
an axially extending gas extraction tube for conveying said off-gas sample from the probe interior, the extraction tube extending from a rearward end spaced towards the distal end of the tubular body to a forward end spaced towards the gas inlet end, the rearward end fluidically communicating with gas conduit,
a filter element mounted to the forward end for filtering particulate matter from the off-gas sample as said off-gas sample is drawn into the extraction tube, and
a heater assembly disposed about said extraction tube,
a probe cooling assembly for cooling the off-gas to a predetermined temperature range as it is drawn from the gas inlet end to the collection tube assembly, said heater assembly and the probe cooling assembly activatable in concert to maintain the off-gas sample within the predetermined temperature range as it is drawn through the filter element and along the gas extraction tube, and wherein said predetermined temperature range is selected less than a thermal degradation temperature of said filter element and higher than a condensation point of water in said off-gas sample.

2. (canceled)

3. The gas sampling probe system of claim 1, wherein said body comprises an inner sidewall and an outer sidewall, wherein said cooling assembly comprises at least one annularly extending liquid coolant fluid passage extending between said inner and outer sidewalls.

4. The gas sampling probe system as claimed in claim 1, wherein said gas stream comprises a steel furnace conversion vessel off-gas stream, and said predetermined temperature range is selected at between about 225° F. and 900° F., and preferably between about 250° F. and 750° F.,
the heater assembly comprises:
a heating coil thermally communicating with and extending along a longitudinal length of said extraction tube,
an insulating jacket disposed about and thermally insulating said heater coil from said probe interior, and
an axially extending shielding tube, said shielding tube substantially encasing and isolating said insulating jacket from the probe interior,
a power supply controller for supplying power to said heating coil, and
at least one temperature sensor electronically communicating with said power supply controller, said at least one temperature sensor operable to provide control signals to said power supply controller in response to a sensed temperature of said off-gas sample along at least a portion of said extraction tube.

5. The gas sample probe system as claimed in claim 1, wherein the gas analyzer assembly further includes:
an analyzer electrically communicating with the sensor for sensing and outputting to said analyzer data representative of water vapour content of said gas stream,
a conduit heater activatable to heat said gas conduit to maintain the off-gas sample therein substantially within said predetermined temperature range.

6. The gas sampling probe system as claimed in claim 5, wherein the heater assembly comprises:
a heater coil thermally communicating with and extending along a longitudinal length of said extraction tube, and
an insulating jacket disposed about and thermally insulating said heater coil from said probe interior.

7. The gas sample probe system as claimed in claim 6, wherein the heater assembly further comprises a generally cylindrical shielding tube, said shielding tube substantially encapsulating and isolating said insulating jacket from said probe interior, and being radially spaced a distance of least about 1 cm, and preferably at least 1.5 cm from said body sidewall,
said shielding tube having a generally smooth outer surface selected to minimize the adherence of process dust and/or debris thereto.

8. The gas sampling probe system as claimed in claim 1, wherein the gas collection tube assembly is provided as an interchangeable modular preassembly, each preassembly characterized by one said gas extraction tube having an axial length selected for locating the forward end a predetermined distance from the gas inlet end to effect desired cooling of said collected off-gas sample prior to drawing through said filter element,
the probe further comprising a coupling for releasably securing the gas collection tube assembly in said probe interior.

9. The gas sampling probe system as claimed in claim 8, wherein the filter element comprises a replaceable stainless steel filter.

10. A gas sampling probe for extracting and conveying a high temperature process off-gas sample from a point of sampling in a gas stream to a gas analyzer assembly, said probe comprising,
an elongated body adapted for positioning within said gas stream and defining a hollow probe interior, said body comprising a gas inlet end open to said body interior and positionable at said point of sampling and providing fluid communication between said gas stream and said probe interior, said body comprising a generally tubular body elongated along an axis and having a sidewall extending radially about said axis, said sidewall comprising at least one coolant fluid passage for cooling said off-gas sample as said off-gas sample is drawn through said gas inlet end into said probe interior and to said filter element,
a gas collection tube assembly disposed within said probe interior, said collection tube assembly including,
a filter element for filtering particulate matter from an off-gas sample collected in the probe interior as said off-gas sample is drawn therethrough,
an axially extending gas extraction tube for conveying said off-gas sample from the probe interior to the gas analyzing assembly, the extraction tube extending from a forward end to a rearward end, the forward end being in fluid communication with said filter element, wherein the filter element is located a predetermined distance from the gas inlet end selected to allow residence time of said off-gas sample in said probe interior to effect cooling of said off-gas sample to a predetermined temperature range,
said predetermined temperature range being selected higher than a condensation point water and lower than a thermal degradation temperature of at least one of said filter element and said gas analyzer assembly, the rearward end being adapted for fluidic communication with said gas analyzer assembly, and
a heater assembly disposed about at least part of said extraction tube and activatable to maintain a temperature of said off-gas sample moving therethrough within a predetermined temperature range.

11. The gas sampling probe of claim 10, wherein said predetermined temperature range is selected less than about 350° F. less than a temperature of said off-gas sample at said point of sampling.

12. (canceled)

13. The gas sampling probe as claimed in claim 10, wherein said gas stream comprises a steel furnace conversion vessel off-gas stream, and said predetermined temperature range is selected at between about 225° F. and 900° F.

14. The gas sampling probe as claimed in claim 10, wherein the heater assembly comprises:
a heater coil thermally communicating with and extending along a longitudinal length of said extraction tube, and
an insulating jacket disposed about and thermally insulating said heater coil from said probe interior.

15. The gas sample probe as claimed in claim 14, wherein the heater assembly further comprises a general cylindrical shielding tube, said shielding tube substantially encapsulating and isolating said insulating jacket from said probe interior, and being radially spaced a distance of at least about 1 cm, and preferably at least 1.5 cm from said body sidewall,
said shielding tube having a generally smooth outer surface selected to minimize the adherence of process dust and/or debris thereto.

16. The gas sampling probe as claimed in claim 14, wherein the heater coil comprises an electric coil, said heater assembly further comprising:
a power supply controller for supplying power to said electric coil, and
at least one temperature sensor electronically communicating with said power supply controller, said temperature sensor for sensing a temperature of said off-gas sample along at least a portion of said extraction tube.

17. The gas sampling probe as claimed in claim 10, wherein the gas analyzer assembly includes:
an analyzer,
a sensor electronically communicating with said analyzer and for sensing and outputting to said analyzer data representative of water vapour content of said process gas sample,
a gas conduit tube fluidically coupled to the rearward end of the gas extraction tube for receiving and conveying the off-gas sample from the collection tube assembly to the sensor for analysis, and
a conduit heater activatable to heat said gas conduit tube to maintain the off-gas sample in the gas conduit tube substantially within said predetermined temperature range.

18. The gas sampling probe as claimed in claim 10, wherein the as collection tube assembly is provided as an interchangeable modular preassembly, each preassembly characterized by one said gas extraction tube having an axial length selected for locating the forward end a predetermined distance from the gas inlet end to effect desired cooling of said collected off-gas sample prior to drawing through said filter element,
the probe further comprising a coupling for releasably securing the gas collection tube assembly in said probe interior.

19. The gas sampling probe as claimed in claim 15, wherein said hollow probe interior comprises a generally vertically elongated cylindrical cavity, said gas inlet end comprising a lowermost open end of said cavity.

20. A non-condensing gas sampling probe for extracting and conveying a high temperature process off-gas sample from a point of sampling in a gas stream, said probe comprising,
an axially elongated tubular body defining a hollow probe interior, said body extending from a proximal gas inlet end open to said body interior to a distal end, and being positionable with said inlet end at said point of sampling to provide fluid communication between said gas stream and said probe interior,
a gas collection tube assembly disposed within said probe interior, said collection tube assembly fluidically coupled to a vacuum source for drawing an off-gas sample from the gas stream through the probe interior, said collection tube assembly including,
an axially extending gas extraction tube for conveying said off-gas sample from the probe interior, the extraction tube extending from a rearward end spaced towards the distal end of the tubular body to a forward end spaced towards the gas inlet end, the rearward end fluidically communicating with said vacuum source,
a filter element mounted to the forward end for filtering particulate matter from the off-gas sample as said off-gas sample is drawn into the extraction tube, and
a heater assembly disposed about said extraction tube,
a probe cooling assembly for cooling the off-gas sample as it is drawn from the gas inlet end to the collection tube assembly, wherein the filter element is located a predetermined distance from the gas inlet end selected to allow residence time of said off-gas sample in said probe interior to effect cooling of said off-gas sample to a predetermined temperature range,
said predetermined temperature range being selected higher than a condensation point of water and lower than a thermal degradation temperature of at least one of said filter element and said gas analyzer assembly, and
wherein said heater is activatable to maintain the off-gas sample within the predetermined temperature range as it is drawn through the filter element and along the gas extraction tube.

21. The gas sampling probe of claim 20, wherein said predetermined temperature range is selected less than a thermal degradation temperature of said filter element and higher that a condensation point of water in said off-gas sample.

22. The gas sampling probe of claim 20, wherein said body comprises an inner sidewall and an outer sidewall, wherein said cooling assembly comprises at least one annularly extending liquid coolant fluid passage extending between said inner and outer sidewalls.

23. The gas sampling probe as claimed in claim 20, wherein said gas stream comprises a steel furnace conversion vessel off-gas stream, and said predetermined temperature range is selected at between about 225° F. and 900° F.,
the heater assembly comprising,
a heating coil thermally communicating with and extending along a longitudinal length of said extraction tube
an insulating jacket disposed about and thermally insulating said heater coil from said probe interior,
an axially extending shielding tube, said shielding tube substantially encasing and isolating said insulating jacket from the probe interior,
a power supply controller for supplying power to said heating coil, and
at least one temperature sensor electronically communicating with said power supply controller, said at least one temperature sensor operable to sense a temperature of said off-gas sample along at least a portion of said extraction tube.

24. The gas sampling probe as claimed in claim 20, wherein the gas collection tube assembly is provided as an interchangeable modular preassembly, each preassembly characterized by one said gas extraction tube having an axial length selected for locating the forward end an associated said predetermined distance from the gas inlet end to effect desired cooling of said collected off-gas sample prior to drawing through said filter element,
the probe further comprising a coupling for releasably securing the gas collection tube assembly in said probe interior.

25. The gas sampling probe of claim 20, wherein said tubular body has a length selected at from about 1 to 2 metres, and said filter element is located within 0.5 metres from the gas inlet end.
